(19) United States
(12) Patent Application Publication
(10) Pub. No.: US 2023/0306922 A1
(43) Pub. Date: Sep. 28, 2023

(54) DISPLAY SYSTEM, METHOD FOR CONTROLLING DISPLAY SYSTEM, AND DRIVER CIRCUIT MOUNTED IN DISPLAY SYSTEM

(71) Applicant: Wacom Co., Ltd., Saitama (JP)

(72) Inventors: Hiroshi MIZUHASHI, Saitama (JP); Yoshihiro KOTANI, Saitama (JP); Kei DOBASHI, Saitama (JP)

(21) Appl. No.: 18/188,201

(22) Filed: Mar. 22, 2023

(30) Foreign Application Priority Data
Mar. 22, 2022 (JP) 2022-045236

(51) Int. Cl. G09G 3/36; G06F 3/0354; G06F 3/046; G06F 3/041

(52) U.S. Cl. CPC G09G 3/3611; G06F 3/03545; G06F 3/046; G06F 3/0412; G09G 2310/0286; G09G 2310/08; G09G 2330/06; G09G 2354/00

(57) ABSTRACT

A display system includes a display device including column signal lines, first row signal lines, second row signal lines, first image elements, and second image elements, and a driver circuit including first drive circuits and second drive circuits, in which each of the first drive circuits, in operation, supplies electric charge to two or more corresponding ones of the first image elements during a first period and extracts the electric charge from the two or more corresponding ones of the first image elements during a second period, and each of the second drive circuits, in operation, supplies electric charge to two or more corresponding ones of the second image elements during a third period, or extracts the electric charge from the two or more corresponding ones of the second image elements during a fourth period.

### BACKGROUND

### Technical Field

The present disclosure relates to a display system, and, in particular, to a display system, a method for controlling the display system, and a driver circuit mounted in the display system.

### Description of the Related Art

In the related art, there are known display systems that have a flat display surface such as a liquid crystal display. In such a display system, image elements are arranged at the intersections between a plurality of column signal lines, which are arranged on a flat surface in a horizontal direction, and a plurality of row signal lines, which are arranged on the flat surface in a vertical direction. Moreover, the display system includes a driver circuit for charging and discharging the image elements. The display system displays an image by sequentially driving the row signal lines by the driver circuit and applying electric charge added to the column signal lines to the respective image elements.

In this regard, PCT Patent Publication No. WO2014/007199 discloses a liquid crystal display device including a liquid crystal display panel and a gate driver. In the liquid crystal display panel, pixel elements are arranged at the intersections between a plurality of gate lines and a plurality of source lines, which are arranged orthogonal to each other. The gate driver drives the plurality of gate lines.

In recent years, due to an increase in size and resolution of display systems, the load capacitance of row signal lines has increased. Accordingly, the magnetic field noise and electric field noise emitted from the row signal lines tend to increase. In addition, the driving frequency of the row signal lines is also increasing, and the periods of generation of the magnetic field noise and electric field noise are becoming shorter. Such magnetic field noise and electric field noise can cause malfunctions and deterioration of accuracy of various electronic components such as sensors mounted in the display systems.

### BRIEF SUMMARY

In view of the foregoing, an object of the present disclosure is to provide a display system, a method for controlling the display system, and a driver circuit mounted in the display system that can reduce noise.

A display system according to a first aspect of the present disclosure includes a display device including a plurality of column signal lines arranged in a horizontal direction, a plurality of first row signal lines arranged in a vertical direction, a plurality of second row signal lines arranged in the vertical direction, a plurality of first image elements arranged at intersections between the first row signal lines and the column signal lines, and a plurality of second image elements arranged at intersections between the second row signal lines and the column signal lines, and a driver circuit including a plurality of first drive circuits each disposed for a corresponding one of the first row signal lines and, in operation, drives two or more corresponding ones of the first image elements via the corresponding one of the first row signal lines, and a plurality of second drive circuits each is disposed for a corresponding one of the second row signal lines and, in operation, drives two or more corresponding ones of the second image elements via the corresponding one of the second row signal lines, in which each of the first drive circuits, in operation, supplies first electric charge to the two or more corresponding ones of the first image elements during a first period and extracts the first electric charge from the two or more corresponding ones of the first image elements during a second period different from the first period, and each of the second drive circuits, in operation, supplies second electric charge to the two or more corresponding ones of the second image elements during a third period, at least part of which overlaps with the second period, or extracts the second electric charge from the two or more corresponding ones of the second image elements during a fourth period, at least part of which overlaps with the first period.

The display system according to a second aspect of the present disclosure further includes a first clock line that couples a first clock to the first drive circuits, and a second clock line that couples a second clock to the second drive circuits, in which each of the first drive circuits, in operation, supplies the first electric charge to or extracts the first electric charge from the two or more corresponding ones of the first image elements according to alternation of the first clock, each of the second drive circuits, in operation, supplies the second electric charge to or extracts the second electric charge from the two or more corresponding ones of the second image elements according to alternation of the second clock, and the first clock line and the second clock line are arranged parallel and adjacent to each other.

The display system according to a third aspect of the present disclosure further includes a first clock line which couples a first clock to the first drive circuits, and a second clock line which couples a second clock to the second drive circuits, in which each of the first drive circuits, in operation, supplies the first electric charge to or extracts the first electric charge from the two or more corresponding ones of the first image elements according to alternation of the first clock, each of the second drive circuits, in operation, supplies the second electric charge to or extracts the second electric charge from the two or more corresponding ones of the second image elements according to alternation of the second clock, and the first clock line and the second clock line are arranged in such a manner as to cross each other at regular distances.

In the display system according to a fourth aspect of the present disclosure, the first drive circuits and the second drive circuits are alternately connected in series, each of the first drive circuits, in operation, retains information indicated by a signal output from a corresponding one of the second drive circuits that is connected to a preceding stage and outputs a signal including the information retained during the first period to a corresponding one of the second drive circuits that is connected to a subsequent stage, each of the second drive circuits, in operation, retains information indicated by a signal output from a corresponding one of the first drive circuits that is connected to a preceding stage and outputs a signal including the information retained during the third period to a corresponding one of the first drive circuits that is connected to a subsequent stage, each of the first drive circuits, in operation, initializes the information retained therein according to a signal output from a corresponding one of the first drive circuits that is connected to a stage immediately following or following the subsequent stage or according to a signal output from a corresponding one of the second drive circuits that is connected to a stage immediately following or following the subsequent stage, and each of the second drive circuits, in operation, initializes the information retained therein according to a signal output from a corresponding one of the first drive circuits that is connected to a stage immediately following or following the subsequent stage or according to a signal output from a corresponding one of the second drive circuits that is connected to a stage immediately following or following the subsequent stage.

In the display system according to a fifth aspect of the present disclosure, the plurality of first drive circuits are alternately connected in series, each of the first drive circuits, in operation, retains information indicated by a signal output from a corresponding one of the first drive circuits that is connected to a preceding stage and outputs a signal including the information retained during the first period to a corresponding one of the first drive circuits that is connected to a subsequent stage, the plurality of second drive circuits are alternately connected in series, and each of the second drive circuits retains information indicated by a signal output from a corresponding one of the second drive circuits that is connected to a preceding stage and outputs a signal including the information retained during the third period to a corresponding one of the second drive circuits that is connected to a subsequent stage.

The display system according to a sixth aspect of the present disclosure further includes a position indicator including a resonance circuit, a drive coil that, in operation, supplies power to the position indicator, and a position detector including an electro-magnetic resonance detection coil that, in operation, detects a position indicated by the position indicator.

In the display system according to a seventh aspect of the present disclosure, the driver circuit is disposed between the position detector and the drive coil and on a side of a side surface of the display device, the first clock line and the second clock line are arranged between the position detector and the drive coil and on a side of a side surface of the driver circuit opposite to the display device, the position detector is disposed on a side of a display surface of the display device with respect to the display device, the driver circuit, the first clock line, and the second clock line, and the drive coil is disposed on a side of a back surface of the display device with respect to the display device, the driver circuit, the first clock line, and the second clock line.

In the display system according to an eighth aspect of the present disclosure, the display device includes a touch sensor including a plurality of detection electrodes arranged in a planar form.

In the display system according to a ninth aspect of the present disclosure, the driver circuit is disposed on a side of a side surface of the display device and on a side of a back surface of the touch sensor, the first clock line and the second clock line are arranged on the side of the back surface of the touch sensor and on a side of a side surface of the driver circuit opposite to the display device, and the touch sensor is disposed on a side of a display surface of the display device with respect to the display device, the driver circuit, the first clock line, and the second clock line.

A driver circuit according to a tenth aspect of the present disclosure is a driver circuit for driving a plurality of first image elements and a plurality of second image elements in a display device, the display device including a plurality of column signal lines arranged in a horizontal direction, a plurality of first row signal lines arranged in a vertical direction, a plurality of second row signal lines arranged in the vertical direction, the plurality of first image elements arranged at intersections between the first row signal lines and the column signal lines, and the plurality of second image elements arranged at intersections between the second row signal lines and the column signal lines, the driver circuit including a plurality of first drive circuits each disposed for a corresponding one of the first row signal lines and, in operation, drives two or more corresponding ones of the first image elements via the corresponding one of the first row signal lines, and a plurality of second drive circuits each disposed for a corresponding one of the second row signal lines and, in operation, drives two or more corresponding ones of the second image elements via the corresponding one of the second row signal lines, in which each of the first drive circuits, in operation, supplies first electric charge to the two or more corresponding ones of the first image elements during a first period and extracts the first electric charge from the two or more corresponding ones of the first image elements during a second period different from the first period, and each of the second drive circuits, in operation, supplies second electric charge to the two or more corresponding ones of the second image elements during a third period, at least part of which overlaps with the second period, or extracts the second electric charge from the two or more corresponding ones of the second image elements during a fourth period, at least part of which overlaps with the first period.

A method according to an eleventh aspect of the present disclosure is a method for controlling a display system, the display system including a plurality of column signal lines arranged in a horizontal direction, a plurality of first row signal lines arranged in a vertical direction, a plurality of second row signal lines arranged in the vertical direction, a plurality of first image elements arranged at intersections between the first row signal lines and the column signal lines, and a plurality of second image elements arranged at intersections between the second row signal lines and the column signal lines, the method including supplying first electric charge to the first image elements via the first row signal lines during a first period, extracting the first electric charge from the first image elements via the first row signal lines during a second period different from the first period; supplying second electric charge to the second image elements via the second row signal lines during a third period, at least part of which overlaps with the second period; and extracting the second electric charge from the second image elements via the second row signal lines during a fourth period, at least part of which overlaps with the first period, extracting the electric charge from the first image elements via the first row signal lines during a second period different from the first period, and supplying the electric charge to the second image elements via the second row signal lines during a third period, at least part of which overlaps with the second period.

According to the present disclosure, the display system can reduce noise.

### BRIEF DESCRIPTION OF THE SEVERAL VIEWS OF THE DRAWINGS

FIG. 1 is a diagram illustrating an example of a display system;

FIG. 2 is a diagram illustrating an example of an image element;

FIG. 3A is a diagram illustrating an example of a circuit configuration of clock lines and a gate driver circuit;

FIG. 3B is a diagram illustrating an example of a circuit configuration of a first shift register;

FIG. 3C is a diagram illustrating an example of a circuit configuration of a block;

FIG. 4 is a diagram illustrating an example of a circuit configuration of a drive circuit;

FIG. 5A is a diagram illustrating a second example of the arrangement of the clock lines;

FIG. 5B is a diagram illustrating a third example of the arrangement of the clock lines;

FIG. 5C is a diagram illustrating a fourth example of the arrangement of the clock lines;

FIG. 6 is a timing chart illustrating a first example of the transition of the potential of each clock in the display system;

FIG. 7 is a timing chart illustrating an example of the transition of the potential of each signal in the drive circuits;

FIG. 8 is a timing chart illustrating a second example of the transition of the potential of each clock in the display system;

FIG. 9A is a cross-sectional view illustrating a fourth example of the display system;

FIG. 9B is a cross-sectional view illustrating a fifth example of the display system;

FIG. 10 is a set of graphs illustrating a relation between the alternation of clocks and an electromotive force generated in a position detector; and

FIG. 11 is a flowchart illustrating an example of a flow of a series of operations of the display system.

### DETAILED DESCRIPTION

Hereinafter, embodiments of the present disclosure (hereinafter each referred to as the “present embodiment”) are described with reference to the accompanying drawings. For ease of understanding, identical constituent components and acts are denoted by the same signs as much as possible in each drawing, and redundant description is omitted.

### First Embodiment

First, a first embodiment is described.

Configurations

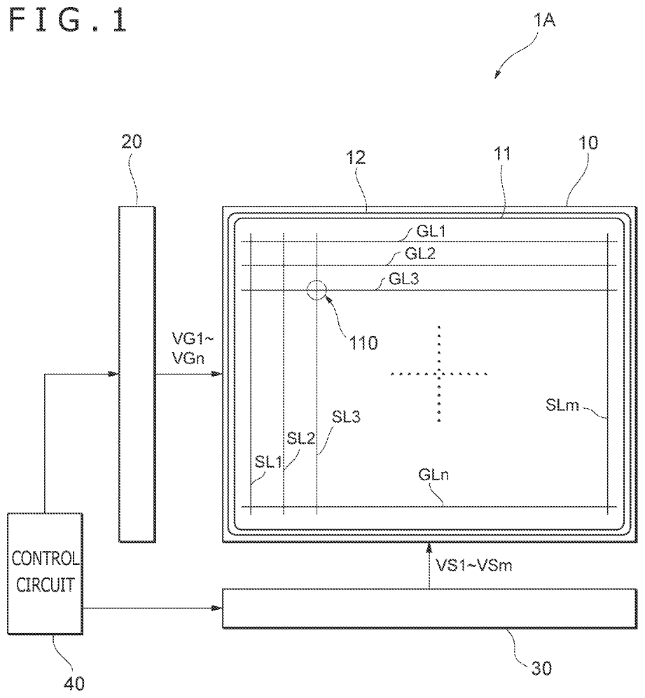

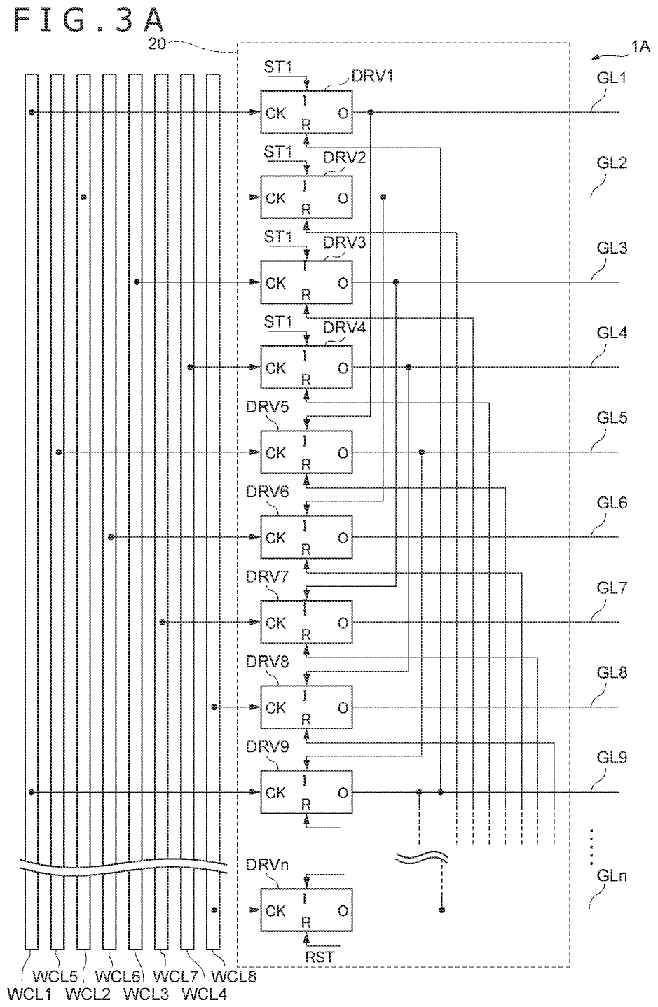

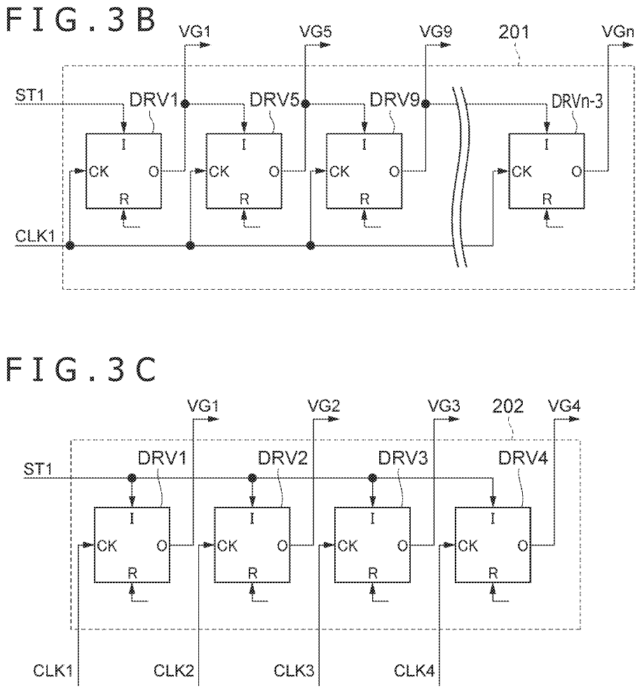

FIG. 1 is a diagram illustrating an example of a display system 1A according to the first embodiment. The display system 1A is a computer, a monitor, or a television (TV) owned by a user. For example, the display system 1A may be a tablet, a smartphone, a monitor of a personal computer, or a TV receiver. In this example, a display device 10 included in the display system 1A is described as a liquid crystal display. The display system 1A includes, for example, the display device 10, a gate driver circuit 20, a source driver circuit 30, a control circuit 40, and clock lines WCL1 to WCL8 (see FIG. 3A).

The display device 10 is, for example, a liquid crystal display. The display device 10 includes, for example, a display module 11 and a backlight module 12.

The display module 11 includes row signal lines GL1 to GLn, which are arranged in a vertical direction, column signal lines SL1 to SLm, which are arranged in a horizontal direction, and image elements 110, each of which is disposed at an intersection between a corresponding one of the row signal lines GL1 to GLn and a corresponding one of the column signal lines SL1 to SLm. The display module 11 drives one of the row signal lines GL1 to GLn according to a corresponding one of gate signals VG1 to VGn transmitted from the gate driver circuit 20, and also drives the image elements 110 corresponding to source signals VS1 to VSm at the luminances indicated by the respective source signals VS1 to VSm transmitted from the source driver circuit 30.

The row signal lines GL1 to GLn are, for example, gate lines. The number of row signal lines GL1 to GLn, which are arranged in the vertical direction in the display device 10, is n. The row signal lines GL1 to GLn are driven by the respective gate signals VG1 to VGn transmitted from the gate driver circuit 20 and relay the exchange of electric charge between gate electrodes of the image elements 110, which are located at the intersections between the row signal lines GL1 to GLn and the column signal lines SL1 to SLm, and the gate driver circuit 20.

The column signal lines SL1 to SLm are, for example, source lines. The number of column signal lines SL1 to SLm, which are arranged in the horizontal direction in the display device 10, is m. The column signal lines SL1 to SLm are driven by the respective source signals VS1 to VSm transmitted from the source driver circuit 30 and relay the exchange of electric charge between source electrodes of the image elements 110, which are located at the intersections between the column signal lines SL1 to SLm and the row signal lines GL1 to GLn, and the source driver circuit 30.

The image elements 110 are, for example, liquid crystal image elements. A total of n×m image elements 110 are arranged at the intersections between the row signal lines GL1 to GLn and the column signal lines SL1 to SLm in the display device 10. Each image element 110 includes a gate electrode connected to one of the row signal lines GL1 to GLn and a source electrode connected to one of the column signal lines SL1 to SLm. When electric charge is supplied to the gate electrode of the image element 110 via the corresponding one of the row signal lines GL1 to GLn, the image element 110 displays an image corresponding to the luminance corresponding to the potential of the corresponding one of the column signal lines SL1 to SLm that is connected to the source electrode of the image element 110.

The backlight module 12 is a light source disposed on a back side of the display module 11 and illuminates the display module 11 from the back side.

The gate driver circuit 20 is a circuit that drives the row signal lines GL1 to GLn and is disposed on the left side of the display device 10 when the display system 1A is viewed from a display surface. The gate driver circuit 20 sequentially drives the row signal lines GL1 to GLn by outputting gate signals VG1 to VGn to the respective row signal lines GL1 to GLn. In this case, the gate driver circuit 20 drives each of the row signal lines GL1 to GLn at the timing based on a corresponding one of clocks CLK1 to CLK8, which are output from the control circuit 40. Further, the gate driver circuit 20 also supplies and extracts electric charge to and from the gate electrodes of the corresponding image elements 110 via the corresponding one of the row signal lines GL1 to GLn that is driven.

The source driver circuit 30 is a circuit that drives the column signal lines SL1 to SLm and is disposed on a lower side of the display device 10 when the display system 1A is viewed from the display surface. The source driver circuit 30 outputs the source signals VS1 to VSm, each of which has a potential to be set for a corresponding one of the column signal lines SL1 to SLm by the control circuit 40 each time, to the respective column signal lines SL1 to SLm at the respective timings according to the control circuit 40. The source driver circuit 30 supplies potentials of the source signals VS1 to VSm corresponding to the image elements 110 to the source electrodes of those image elements 110 corresponding to the intersections between the corresponding one of the row signal lines GL1 to GLn that is driven by the gate driver circuit 20 and the column signal lines SL1 to SLm.

The control circuit 40 is a circuit for controlling the display device 10. When the gate driver circuit 20 starts driving the row signal lines GL1 to GLn, the control circuit 40 generates start signals ST1 to ST4, which indicate the start of the driving, and outputs the start signals ST1 to ST4 to the gate driver circuit 20. Further, the control circuit 40 generates the clocks CLK1 to CLK8 used for operating the gate driver circuit 20 and outputs the clocks CLK1 to CLK8 to the gate driver circuit 20 via the clock lines WCL1 to WCL8.

Further, the control circuit 40 generates a clock used for operating the source driver circuit 30 and outputs the clock to the source driver circuit 30. The control circuit 40 also sets the potentials to be supplied to the source electrodes of the corresponding image elements 110 via the column signal lines SL1 to SLm and outputs a signal including information regarding the set potentials to the source driver circuit 30.

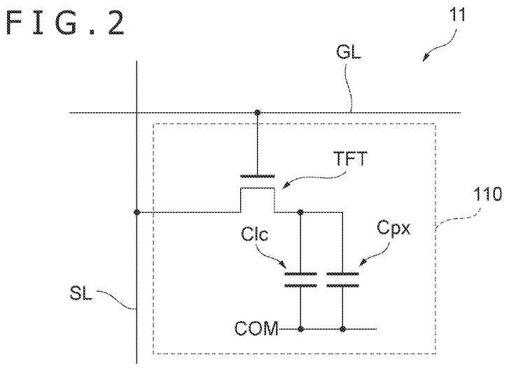

FIG. 2 is a diagram illustrating an example of the image element 110 according to the first embodiment. As illustrated in FIG. 2, the image element 110 includes, for example, a thin-film transistor TFT, a liquid crystal electrode Clc, and a capacitive element Cpx.

The thin-film transistor TFT functions as a switching element in the image element 110. A gate electrode of the thin-film transistor TFT is connected to one of the row signal lines GL. A source electrode of the thin-film transistor TFT is connected to one of the column signal lines SL. A drain electrode of the thin-film transistor TFT is connected to one end of each of the liquid crystal electrode Clc and the capacitive element Cpx. When electric charge is supplied to the gate electrode via the row signal line GL, the thin-film transistor TFT sets the state between the source electrode and the drain electrode to a conducting state. When electric charge is extracted from the gate electrode via the row signal line GL, the thin-film transistor TFT sets the state between the source electrode and the drain electrode to a non-conducting state. When there is no change in the potential applied to the gate electrode, the thin-film transistor TFT maintains the state between the source electrode and the drain electrode.

The liquid crystal electrode Clc is an electrode for supplying the potential to the liquid crystal. One end of the liquid crystal electrode Clc is connected to the drain electrode of the thin-film transistor TFT and one end of the capacitive element Cpx. The other end of the liquid crystal electrode Clc is connected to a common electrode COM via the liquid crystal. The liquid crystal electrode Clc supplies, to the liquid crystal, the potential supplied from the capacitive element Cpx.

The capacitive element Cpx is, for example, a capacitor and retains the potential to be supplied to the liquid crystal electrode Clc. One end of the capacitive element Cpx is connected to the drain electrode of the thin-film transistor TFT and one end of the liquid crystal electrode Clc. The other end of the capacitive element Cpx is connected to the common electrode COM. When the thin-film transistor TFT is in the conducting state, the capacitive element Cpx retains the potential supplied from the column signal line SL. When the thin-film transistor TFT is in the non-conducting state, the capacitive element Cpx supplies the retained potential to the liquid crystal electrode Clc.

When electric charge is supplied to the gate electrode of the thin-film transistor TFT via the row signal line GL, the image element 110 having the configuration described above sets the state of the thin-film transistor TFT to the conducting state and supplies the potential of the column signal line SL to the capacitive element Cpx, so that the potential supplied via the column signal line SL is retained by the capacitive element Cpx. Further, when electric charge is extracted from the gate electrode of the thin-film transistor TFT via the row signal line GL, the image element 110 sets the state of the thin-film transistor TFT to the non-conducting state and supplies the potential retained by the capacitive element Cpx to the liquid crystal electrode Clc, thereby controlling the liquid crystal to be in the state based on the supplied potential.

FIG. 3A is a diagram illustrating an example of a circuit configuration of the clock lines WCL1 to WCL8 and the gate driver circuit 20 according to the first embodiment. As illustrated in FIG. 3A, the gate driver circuit 20 includes, for example, n drive circuits DRV.

In the gate driver circuit 20, each of the n drive circuits DRV is disposed for a corresponding one of the n row signal lines GL1 to GLn. The gate driver circuit 20 outputs a gate signal VG to a corresponding one of the row signal lines GL1 to GLn at a timing based on a corresponding one of the clocks CLK1 to CLK8, each of which is supplied to a corresponding one of the clock lines WCL1 to WCL8 from the control circuit 40.

Further, each of the drive circuits DRV constitutes a shift register 201, together with other drive circuits DRV (see FIG. 3B). In the present embodiment, the gate driver circuit 20 includes four shift registers 201, each of which includes a group of different drive circuits DRV. Further, the drive circuits DRV at the same stage among the shift registers 201 forms a block 202. In the block 202, the drive circuit DRV in the first shift register 201 to the drive circuit DRV in the fourth shift register 201 are arranged in this order in the vertical direction (see FIG. 3C). The blocks 202 are arranged in the order from the first row to the last row of the stages of the shift registers 201 in the vertical direction in the gate driver circuit 20.

Each drive circuit DRV includes a clock terminal CK, an input terminal I, an output terminal O, and a reset terminal R. The clock terminal CK is connected to a corresponding one of the clock lines WCL1 to WCL8. The input terminal I is connected to an output terminal O of the drive circuit DRV at the preceding stage. The output terminal O is connected to a corresponding one of the row signal lines GL1 to GLn, an input terminal I of the drive circuit DRV at the subsequent stage, and a reset terminal R of the drive circuit DRV at the stage preceding the preceding stage. The reset terminal R is connected to an output terminal O of the drive circuit DRV at the stage immediately following the subsequent stage. The input terminal I of the drive circuit DRV at the frontmost stage in each shift register 201 is connected to the control circuit 40, instead of the output terminal O of the drive circuit DRV at the preceding stage. A corresponding one of the start signals ST1 to ST4 output from the control circuit 40 is input into the input terminal I of the drive circuit DRV at the frontmost stage in each shift register 201. Further, in each shift register 201, the control circuit 40 is connected to the reset terminal R of the drive circuit DRV which has no stage following the subsequent stage, and a reset signal RST output from the control circuit 40 is input thereto.

The shift register 201 is described with reference to FIG. 3B. FIG. 3B is a diagram illustrating an example of a circuit configuration of the first shift register 201 according to the first embodiment. As illustrated in FIG. 3B, the shift register 201 includes, for example, the drive circuits DRV1, DRV5, DRV9, . . . and DRVn−3.

As illustrated in FIG. 3B, the drive circuit DRV1 outputs the gate signal VG1, which includes information indicated by the start signal ST1 input into the input terminal I, to the drive circuit DRV5 from the output terminal O at a timing based on the clock CLK1. Similarly, the drive circuits DRV5, DRV9, . . . , and DRVn−3 respectively output gate signals VG5, VG9, . . . , and VGn−3 to the drive circuits DRV at the respective subsequent stages from the respective output terminals O. Each of the gate signals VG5, VG9, . . . , and VGn−3 includes information indicated by a signal input into the corresponding input terminal I.

Next, the blocks 202 are described with reference to FIG. 3C. FIG. 3C is a diagram illustrating an example of a circuit configuration of the block 202 according to the first embodiment. As illustrated in FIG. 3C, the block 202 includes, for example, the drive circuits DRV1 to DRV4.

As illustrated in FIG. 3C, the drive circuits DRV1 to DRV4 output the gate signals VG1 to VG4 from the respective output terminals O at the timings according to the clocks CLK1 to CLK4, respectively. Each of the gate signals VG1 to VG4 includes information indicated by the start signal ST1 input into the corresponding input terminal I.

Described with reference to FIG. 3A again, the clock lines WCL1 to WCL8 are signal lines used to respectively supply, to the gate driver circuit 20, the clocks CLK1 to CLK8 output from the control circuit 40. The clock lines WCL1 to WCL8 are arranged on the left side of the gate driver circuit 20 when the display system 1A is viewed from the display surface. The eight clock lines WCL1, WCL5, WCL2, WCL6, WCL3, WCL7, WCL4, and WCL8 are aligned in this order from the left side in the horizontal direction.

The clock line WCL1 supplies the clock CLK1 input from the control circuit 40, to the clock terminals CK of the drive circuits DRV1, DRV9, . . . , and DRVn−7 at the odd-numbered stages in the first shift register 201 among the four shift registers 201.

The clock line WCL5 supplies the clock CLK5 input from the control circuit 40, to the clock terminals CK of the drive circuits DRV5, DRV13, . . . , and DRVn−3 at the even-numbered stages in the first shift register 201 among the four shift registers 201. The control circuit 40 generates the clock CLK5 in such a manner that the phase of the clock CLK5 is opposite to that of the clock CLK1.

The clock line WCL2 supplies the clock CLK2 input from the control circuit 40, to the clock terminals CK of the drive circuits DRV2, DRV10, . . . , and DRVn−6 at the odd-numbered stages in the second shift register 201 among the four shift registers 201.

The clock line WCL6 supplies the clock CLK6 input from the control circuit 40 to the clock terminals CK of the drive circuits DRV6, DRV14, . . . , and DRVn−2 at the even-numbered stages in the second shift register 201 among the four shift registers 201. The control circuit 40 generates the clock CLK6 in such a manner that the phase of the clock CLK6 is opposite to that of the clock CLK2.

The clock line WCL3 supplies the clock CLK3 input from the control circuit 40, to the clock terminals CK of the drive circuits DRV3, DRV11, . . . , and DRVn−5 at the odd-numbered stages in the third shift register 201 among the four shift registers 201.

The clock line WCL7 supplies the clock CLK7 input from the control circuit 40, to the clock terminals CK of the drive circuits DRV7, DRV15, . . . , and DRVn−1 at the even-numbered stages in the third shift register 201 among the four shift registers 201. The control circuit 40 generates the clock CLK7 in such a manner that the phase of the clock CLK7 is opposite to that of the clock CLK3.

The clock line WCL4 supplies the clock CLK4 input from the control circuit 40, to the clock terminals CK of the drive circuits DRV4, DRV12, . . . , and DRVn−4 at the odd-numbered stages in the fourth shift register 201 among the four shift registers 201.

The clock line WCL8 supplies the clock CLK8 input from the control circuit 40, to the clock terminals CK of the drive circuits DRV8, DRV16, . . . , and DRVn at the even-numbered stages in the fourth shift register 201 among the four shift registers 201. The control circuit 40 generates the clock CLK8 in such a manner that the phase of the clock CLK8 is opposite to that of the clock CLK4.

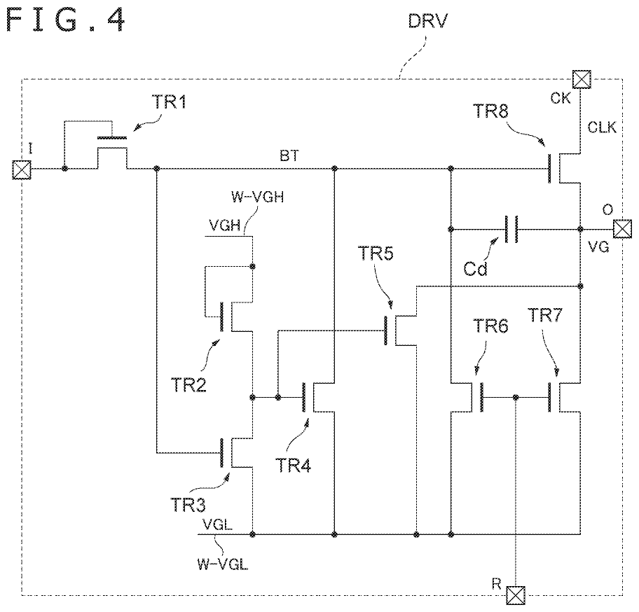

FIG. 4 is a diagram illustrating an example of a circuit configuration of the drive circuit DRV according to the first embodiment. As illustrated in FIG. 4, the drive circuit DRV includes transistors TR1 to TR8 and a capacitive element Cd.

The transistors TR1 to TR8 are, for example, N-channel metal-oxide semiconductor (NMOS) transistors. The transistors TR1 to TR8 set the state between their drain and source terminals to a conducting state when the potential difference between the gate and source terminals is equal to or greater than a predetermined value. On the other hand, the transistors TR1 to TR8 set the state between the drain and source terminals to a non-conducting state when the potential difference between the gate and source terminals is less than the predetermined value. In the present embodiment, the transistors TR1 to TR8 are described as NMOS transistors. However, the transistors TR1 to TR8 are not limited thereto and may be P-channel MOS (PMOS) transistors.

The drain terminal and the gate terminal of the transistor TR1 are diode-connected to the input terminal I of the drive circuit DRV. While the potentials of the gate terminal and the drain terminal are higher than the potential of the source terminal, the transistor TR1 supplies electric charge supplied from the input terminal I, to the capacitive element Cd from the source terminal via a node BT. The gate terminal and the drain terminal of the transistor TR1 are connected to the input terminal I of the drive circuit DRV. The source terminal of the transistor TR1 is connected to the node BT.

The drain terminal and the gate terminal of the transistor TR2 are diode-connected to a power supply line W_VGH. While the potentials of the gate terminal and the drain terminal are higher than the potential of the source terminal, the transistor TR2 supplies the potential supplied from the power supply line W_VGH, to the gate terminals of the transistors TR4 and TR5 from the source terminal. The gate terminal and the drain terminal of the transistor TR2 are connected to the power supply line W_VGH. The source terminal of the transistor TR2 is connected to the drain terminal of the transistor TR3 and the gate terminals of the transistors TR4 and TR5.

The transistor TR3 supplies the potential of a reference line W_VGL, which is connected to the source terminal of the transistor TR3, to the gate terminals of the transistors TR4 and TR5 from the drain terminal of the transistor TR3 according to the potential of the node BT input into the gate terminal of the transistor TR3. The gate terminal of the transistor TR3 is connected to the node BT. The drain terminal of the transistor TR3 is connected to the source terminal of the transistor TR2 and the gate terminals of the transistors TR4 and TR5. The source terminal of the transistor TR3 is connected to the reference line W_VGL.

The transistor TR4 supplies the potential of the reference line W_VGL, which is connected to the source terminal of the transistor TR4, to the node BT from the drain terminal of the transistor TR4 according to the potential input into the gate terminal of the transistor TR4. The gate terminal of the transistor TR4 is connected to the source terminal of the transistor TR2, the drain terminal of the transistor TR3, and the gate terminal of the transistor TR5. The drain terminal of the transistor TR4 is connected to the node BT. The source terminal of the transistor TR4 is connected to the reference line W_VGL.

The transistor TR5 supplies the potential of the reference line W_VGL, which is connected to the source terminal of the transistor TR5, to the output terminal O of the drive circuit DRV from the drain terminal of the transistor TR5 according to the potential input into the gate terminal of the transistor TR5. The gate terminal of the transistor TR5 is connected to the source terminal of the transistor TR2, the drain terminal of the transistor TR3, and the gate terminal of the transistor TR4. The drain terminal of the transistor TR5 is connected to the output terminal O of the drive circuit DRV. The source terminal of the transistor TR5 is connected to the reference line W_VGL.

The transistor TR6 supplies the potential of the reference line W_VGL, which is connected to the source terminal of the transistor TR6, to the node BT from the drain terminal of the transistor TR6 according to the potential input into the gate terminal of the transistor TR6. The gate terminal of the transistor TR6 is connected to the reset terminal R of the drive circuit DRV. The drain terminal of the transistor TR6 is connected to the node BT. The source terminal of the transistor TR6 is connected to the reference line W_VGL.

The transistor TR7 supplies the potential of the reference line W_VGL, which is connected to the source terminal of the transistor TR7, to the output terminal O of the drive circuit DRV from the drain terminal of the transistor TR7 according to the potential input into the gate terminal of the transistor TR7. The gate terminal of the transistor TR7 is connected to the reset terminal R of the drive circuit DRV. The drain terminal of the transistor TR7 is connected to the output terminal O of the drive circuit DRV. The source terminal of the transistor TR7 is connected to the reference line W_VGL.

The transistor TR8 supplies the potential of a clock CLK, which is supplied from the clock terminal CK of the drive circuit DRV connected to the drain terminal of the transistor TR8, to the output terminal O of the drive circuit DRV from the source terminal of the transistor TR8 according to the potential input into the gate terminal of the transistor TR8. The gate terminal of the transistor TR8 is connected to the node BT. The drain terminal of the transistor TR8 is connected to the clock terminal CK of the drive circuit DRV. The source terminal of the transistor TR8 is connected to the output terminal O of the drive circuit DRV.

The capacitive element Cd is, for example, a capacitor and retains the potential of the node BT by charging the electric charge supplied from the source terminal of the transistor TR1 via the node BT. One end of the capacitive element Cd is connected to the node BT, and the other end of the capacitive element Cd is connected to the output terminal O of the drive circuit DRV.

In the drive circuit DRV configured as described above, when the reset terminal R and the node BT have a potential VGL (low level) of the reference line W_VGL, each of the transistors TR3, TR6, TR7, and TR8 enters the non-conducting state. Accordingly, the potential of the source terminal of the transistor TR2, which is diode-connected to the power supply line W_VGH, becomes a potential VGH (high level) of the power supply line W_VGH, and the transistors TR4 and TR5 enter the conducting state. When the transistors TR4 and TR5 enter the conducting state, each of the node BT and the output terminal O is short-circuited to the reference line W_VGL via the transistors TR4 and TR5, as a result of which the potentials of the node BT and the output terminal O come to have the low level. Hence, the drive circuit DRV outputs, from the output terminal O, a gate signal VG whose potential is at the low level.

Next, when a high level potential is supplied to the input terminal I while the potential of the node BT is at the low level, the transistor TR1 supplies electric charge to one end of the capacitive element Cd via the node BT, thereby charging the capacitive element Cd. When the capacitive element Cd is charged and the potential of the node BT reaches the high level, the transistors TR1, TR3, and TR8 are in the “non-conducting state,” the “conducting state,” and the “conducting state,” respectively. Accordingly, the transistors TR4 and TR5 enter the non-conducting state. Hence, the drive circuit DRV outputs the gate signal VG from the output terminal O by setting, as the gate signal VG, the clock CLK input from the clock terminal CK.

Next, when the high level potential is supplied to the reset terminal R while the potential of the node BT is at the high level, the transistors TR6 and TR7 enter the conducting state. Accordingly, each of the node BT and the output terminal O is short-circuited to the reference line W_VGL via the transistors TR6 and TR7, as a result of which the potentials of the node BT and the output terminal O come to have the low level. Moreover, since the transistors TR3 and TR8 enter the non-conducting state, the transistors TR4 and TR5 enter the conducting state accordingly. Hence, the drive circuit DRV outputs, from the output terminal O, the gate signal VG whose potential is at the low level.

When the low level potential is supplied to the reset terminal R while the potential of the node BT is at the low level, the transistors TR6 and TR7 enter the non-conducting state. Since the transistors TR4 and TR5 remain in the non-conducting state, the drive circuit DRV keeps outputting, from the output terminal O, the gate signal VG whose potential is at the low level.

Flow of Series of Operations of Display System 1A

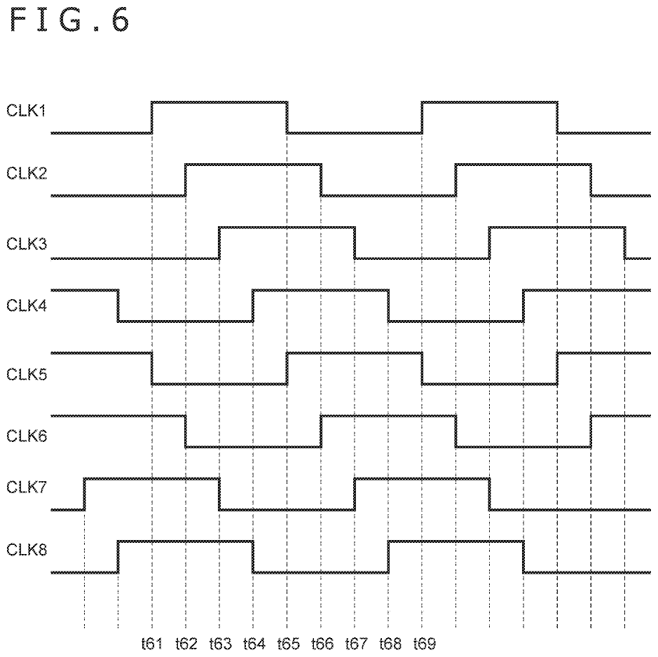

The configuration of the display system 1A has been described above. Next, the transition of the potentials of the clocks CLK1 to CLK8 in the display system 1A is described in detail. FIG. 6 is a timing chart illustrating a first example of the transition of the potentials of the clocks CLK1 to CLK8 in the display system 1A according to the first embodiment.

At time t61, the control circuit 40 causes the potential of the clock CLK1 to transition from the low level to the high level and also causes the potential of the clock CLK5 to transition from the high level to the low level.

At time t62, the control circuit 40 causes the potential of the clock CLK2 to transition from the low level to the high level and also causes the potential of the clock CLK6 to transition from the high level to the low level.

At time t63, the control circuit 40 causes the potential of the clock CLK3 to transition from the low level to the high level and also causes the potential of the clock CLK7 to transition from the high level to the low level.

At time t64, the control circuit 40 causes the potential of the clock CLK4 to transition from the low level to the high level and also causes the potential of the clock CLK8 to transition from the high level to the low level.

At time t65, the control circuit 40 causes the potential of the clock CLK1 to transition from the high level to the low level and also causes the potential of the clock CLK5 to transition from the low level to the high level.

At time t66, the control circuit 40 causes the potential of the clock CLK2 to transition from the high level to the low level and also causes the potential of the clock CLK6 to transition from the low level to the high level.

At time t67, the control circuit 40 causes the potential of the clock CLK3 to transition from the high level to the low level and also causes the potential of the clock CLK7 to transition from the low level to the high level.

At time t68, the control circuit 40 causes the potential of the clock CLK4 to transition from the high level to the low level and also causes the potential of the clock CLK8 to transition from the low level to the high level.

At and after time t69, the control circuit 40 causes the potentials of the clocks CLK1 to CLK8 to transition in the same manner as that in time t61 to time t68.

In this example, the control circuit 40 generates the clocks CLK1 to CLK8 in such a manner that the phases of the clocks CLK1 to CLK4, which are input into the drive circuits DRV at the odd-numbered stages of the shift registers 201 in the gate driver circuit 20, are opposite to the phases of the clocks CLK5 to CLK8, which respectively correspond to the clocks CLK1 to CLK4 and which are input into the drive circuits DRV at the even-numbered stages of the shift registers 201 in the gate driver circuit 20. However, the present example is not limited thereto. Until completion of charging or discharging of the image elements 110 driven via the row signal lines GL by the drive circuits DRV to which the clocks CLK1 to CLK4 are supplied, the phases of the clocks CLK5 to CLK8 generated by the control circuit 40 may be shifted from the opposite phases of the clocks CLK1 to CLK4.

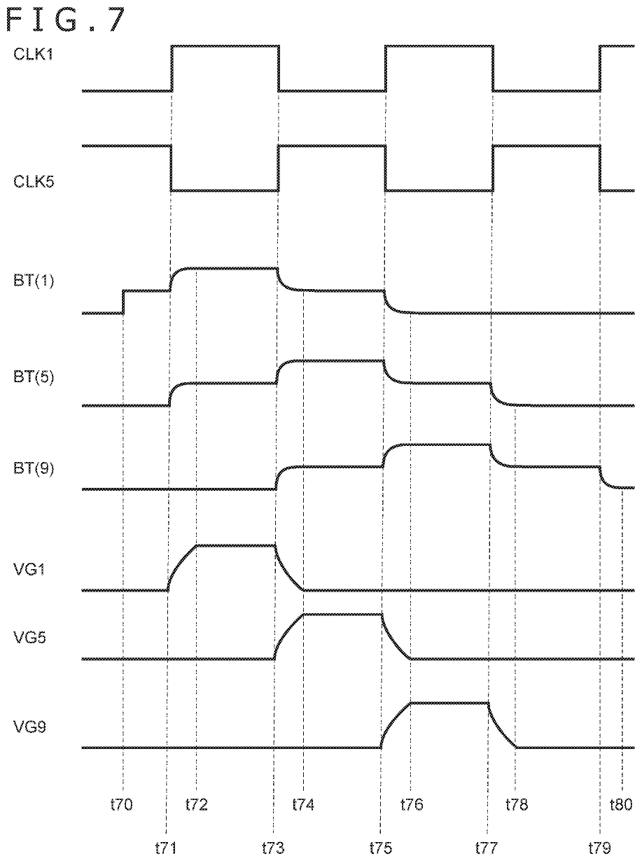

The transition of the potentials of the clocks CLK1 to CLK8 in the display system 1A has been described above. Next, the transition of the potential of each signal in the drive circuits DRV of the display system 1A is described in detail. FIG. 7 is a timing chart illustrating an example of the transition of the potential of each signal in the drive circuits DRV according to the first embodiment. In FIG. 7, nodes BT(1), BT(5), and BT(9) respectively represent the nodes BT of the drive circuits DRV1, DRV5, and DRV9 at the first to third stages of the shift register 201.

At time t70, the control circuit 40 sets the potential of the start signal ST1 to the high level and outputs the start signal ST1 to the input terminal I of the drive circuit DRV1 at the first stage. At time t70, in association with the supply of the high level potential to the input terminal I, the capacitive element Cd in the drive circuit DRV1 at the first stage is charged, and the potential of the node BT(1) transitions to the high level.

At time t71, the control circuit 40 causes the potential of the clock CLK1 to transition from the low level to the high level and also outputs the clock CLK1 to the clock terminal CK of the drive circuit DRV1 at the first stage and the clock terminal CK of the drive circuit DRV9 at the third stage. At time t71, in association with the supply of the high level potential to the clock terminal CK, the potential of one end of the capacitive element Cd in the drive circuit DRV1 at the first stage is increased, and the potential of the node BT(1) starts to transition from the high level to twice the high level. Moreover, at time t71, the potential of the gate signal VG1 output from the drive circuit DRV1 at the first stage to the row signal line GL1 and the input terminal I of the drive circuit DRV5 at the second stage starts to transition from the low level to the high level.

Further, at time t71, the control circuit 40 also causes the potential of the clock CLK5 to transition from the high level to the low level and also outputs the clock CLK5 to the clock terminal CK of the drive circuit DRV5 at the second stage. At time t71, in association with the input of the gate signal VG1 from the drive circuit DRV1 at the first stage into the input terminal I of the drive circuit DRV5 at the second stage, the potential of the node BT(5) starts to transition from the low level to the high level.

At time t72, the potential of the gate signal VG1 reaches the high level. Accordingly, at time t72, the potential of the node BT(1) reaches twice the high level. Moreover, at time t72, the potential of the node BT(5) reaches the high level.

At time t73, the control circuit 40 causes the potential of the clock CLK1 to transition from the high level to the low level and also outputs the clock CLK1 to the clock terminal CK of the drive circuit DRV1 at the first stage and the clock terminal CK of the drive circuit DRV9 at the third stage. Further, at time t73, the control circuit 40 causes the potential of the start signal ST1 to transition from the high level to the low level. At time t73, in association with the supply of the low level potential to the clock terminal CK, the potential of one end of the capacitive element Cd in the drive circuit DRV1 at the first stage is decreased, and the potential of the node BT(1) starts to transition from twice the high level to the high level. Moreover, at time t73, the potential of the gate signal VG1 output from the drive circuit DRV1 at the first stage to the row signal line GL1 and the input terminal I of the drive circuit DRV5 at the second stage starts to transition from the high level to the low level.

Further, at time t73, the control circuit 40 causes the potential of the clock CLK5 to transition from the low level to the high level and also outputs the clock CLK5 to the clock terminal CK of the drive circuit DRV5 at the second stage. At time t73, in association with the supply of the high level potential to the clock terminal CK, the potential of one end of the capacitive element Cd in the drive circuit DRV5 at the second stage is increased, and the potential of the node BT(5) starts to transition from the high level to twice the high level. Moreover, at time t73, the potential of the gate signal VG5 output from the drive circuit DRV5 at the second stage to the row signal line GL5 and the input terminal I of the drive circuit DRV9 at the third stage starts to transition from the low level to the high level.

Moreover, at time t73, in association with the input of the gate signal VG5 from the drive circuit DRV5 at the second stage into the input terminal I of the drive circuit DRV9 at the third stage, the potential of the node BT(9) starts to transition from the low level to the high level.

At time t74, the potential of the gate signal VG1 reaches the low level. Accordingly, at time t74, the potential of the node BT(1) reaches the high level. Moreover, at time t74, the potential of the gate signal VG5 reaches the high level. Accordingly, at time t74, the potential of the node BT(5) reaches twice the high level. Further, at time t74, the potential of the node BT(9) reaches the high level.

At time t75, the control circuit 40 causes the potential of the clock CLK1 to transition from the low level to the high level and outputs the clock CLK1 to the clock terminals CK of the drive circuits DRV at the first and third stages. At time t75, in association with the input of the gate signal VG9 into the reset terminal R, the potential of the node BT(1) starts to transition from the high level to the low level.

Further, at time t75, the control circuit 40 causes the potential of the clock CLK5 to transition from the high level to the low level and also outputs the clock CLK5 to the clock terminal CK of the drive circuit DRV5 at the second stage. At time t75, in association with the supply of the low level potential to the clock terminal CK, the potential of one end of the capacitive element Cd in the drive circuit DRV5 at the second stage is decreased, and the potential of the node BT(5) starts to transition from twice the high level to the high level.

Moreover, at time t75, in association with the input of the gate signal VG5 into the input terminal I of the drive circuit DRV9 at the third stage, the potential of one end of the capacitive element Cd in the drive circuit DRV9 at the third stage is increased, and the potential of the node BT(9) starts to transition from the high level to twice the high level. Further, at time t75, the potential of the gate signal VG9 output from the drive circuit DRV9 at the third stage to the row signal line GL9, the input terminal I of the drive circuit DRV13 at the fourth stage, and the reset terminal R of the drive circuit DRV1 at the first stage starts to transition from the low level to the high level.

At time t76, the potential of the gate signal VG1 remains at the low level. At time t76, the potential of the gate signal VG5 reaches the low level. Accordingly, at time t76, the potential of the node BT(5) reaches the high level. Further, at time t76, the potential of the gate signal VG9 reaches the high level. Accordingly, at time t76, the potential of the node BT(1) reaches the low level. Further, at time t76, the potential of the node BT(9) reaches twice the high level.

At time t77, the control circuit 40 causes the potential of the clock CLK1 to transition from the high level to the low level and also outputs the clock CLK1 to the clock terminal CK of the drive circuit DRV1 at the first stage and the clock terminal CK of the drive circuit DRV9 at the third stage.

At time t77, the control circuit 40 causes the potential of the clock CLK5 to transition from the low level to the high level and also outputs the clock CLK5 to the clock terminal CK of the drive circuit DRV5 at the second stage. At time t77, in association with the input of the gate signal VG13 into the reset terminal R, the potential of the node BT(5) starts to transition from the high level to the low level.

Moreover, at time t77, in association with the supply of the low level potential to the clock terminal CK, the potential of one end of the capacitive element Cd in the drive circuit DRV9 at the third stage is decreased, and the potential of the node BT(9) starts to transition from twice the high level to the high level. Further, at time t77, the potential of the gate signal VG9 starts to transition from the high level to the low level.

At time t78, the potentials of the gate signals VG1 and VG5 remain at the low level. Further, at time t78, the potential of the gate signal VG9 reaches the low level. Moreover, at time t78, since the potential of the gate signal VG13 reaches the low level, the potential of the node BT(5) reaches the low level accordingly.

At time t79, the control circuit 40 causes the potential of the clock CLK1 to transition from the low level to the high level and also outputs the clock CLK1 to the clock terminal CK of the drive circuit DRV1 at the first stage and the clock terminal CK of the drive circuit DRV9 at the third stage. Further, at time t79, the control circuit 40 causes the potential of the clock CLK5 to transition from the high level to the low level and also outputs the clock CLK5 to the clock terminal CK of the drive circuit DRV5 at the second stage. Moreover, at time t79, in association with the input of the gate signal VG17 into the reset terminal R, the potential of the node BT(9) starts to transition from the high level to the low level.

At time t80, the potentials of the gate signals VG1, VG5, and VG9 remain at the low level. Further, at time t80, since the potential of the gate signal VG17 reaches the low level, the potential of the node BT(9) reaches the low level accordingly.

In this example, the control circuit 40 generates the clocks CLK1 and CLK5 in such a manner that the phase of the clock CLK1, which is input into the drive circuits DRV at the odd-numbered stages of the shift register 201 in the gate driver circuit 20, is opposite to the phase of the CLK5, which corresponds to the clock CLK1 and which is input into the drive circuits DRV at the even-numbered stages of the shift register 201 in the gate driver circuit 20. However, the present example is not limited thereto. Until completion of charging or discharging of the image elements 110 driven via the row signal lines GL1 and GL9 by the drive circuits DRV1 and DRV9 to which the clock CLK1 is supplied, the phase of the clock CLK5 generated by the control circuit 40 may be shifted from the opposite phase of the clock CLK1.

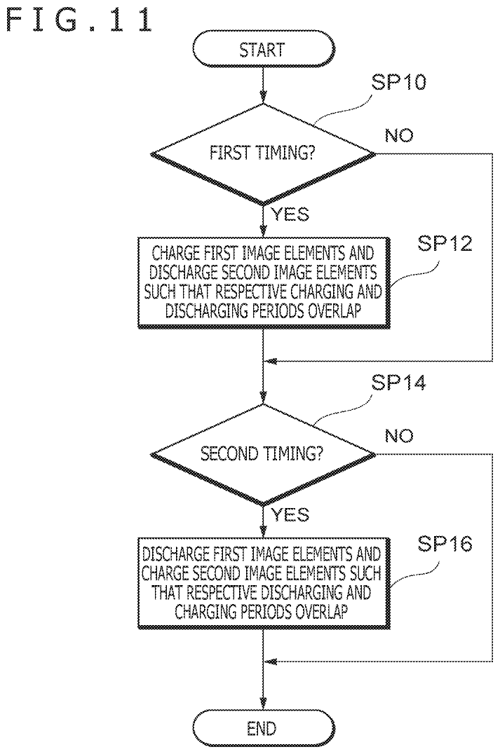

The transition of the potential of each signal in the drive circuits DRV of the display system 1A has been described above. Next, a flow of a series of processes of the display system 1A is described in detail. FIG. 11 is a flowchart illustrating an example of a series of processes of the display system 1A according to the first embodiment.

### SP10

The control circuit 40 determines whether or not the time is at the first timing (time t71, t75, or t79 in FIG. 7), which is the timing to raise the clock (clock CLK1 in FIG. 7) to be supplied to the drive circuits DRV at the odd-numbered stages in any of the shift registers 201 of the gate driver circuit 20 or the timing to lower the clock (clock CLK5 in FIG. 7) to be supplied to the drive circuits DRV at the even-numbered stages in this shift register 201. When the determination result is affirmative, the processing proceeds to SP12. When the determination result is negative, the processing proceeds to SP14.

### SP12

The control circuit 40 causes the drive circuits DRV to drive the respective row signal lines GL in such a manner that a first period (a period from time t75 to t76 in FIG. 7) in which electric charge is supplied to the image elements 110 (first image elements) corresponding to the drive circuit DRV at the odd-numbered stage overlaps with a fourth period (a period from time t75 to t76 in FIG. 7) in which electric charge is extracted from the image elements 110 (second image elements) corresponding to the drive circuit DRV at the even-numbered stage. Accordingly, the control circuit 40 charges the image elements 110 (first image elements) while discharging the image elements 110 (second image elements). After that, the processing proceeds to SP14.

### SP14

The control circuit 40 determines whether or not the time is at the second timing (time t73 or t77 in FIG. 7), which is the timing to lower the clock (clock CLK1 in FIG. 7) to be supplied to the drive circuits DRV at the odd-numbered stages in any of the shift registers 201 of the gate driver circuit 20 or the timing to raise the clock (clock CLK5 in FIG. 7) to be supplied to the drive circuits DRV at the even-numbered stages in this shift register 201. When the determination result is affirmative, the processing proceeds to SP16. When the determination result is negative, the series of processes illustrated in FIG. 11 ends.

### SP16

The control circuit 40 causes the drive circuits DRV to drive the respective row signal lines GL in such a manner that a second period (a period from time t73 to t74 in FIG. 7) in which electric charge is extracted from the image elements 110 (first image elements) corresponding to the drive circuit DRV at the odd-numbered stage overlaps with a third period (the period from time t73 to t74 in FIG. 7) in which electric charge is supplied to the image elements 110 (second image elements) corresponding to the drive circuit DRV at the even-numbered stage. Accordingly, the control circuit 40 discharges the image elements 110 (first image elements) while charging the image elements 110 (second image elements).

### Advantageous Effects

In the first embodiment described above, the display system 1A includes the display device 10 including the plurality of column signal lines SL1 to SLm, which are arranged in the horizontal direction, the plurality of row signal lines GL (first row signal lines: GL1 to GL4, GL9 to GL12, . . . , GLn−7 to GLn−4), which are arranged in the vertical direction, the plurality of row signal lines GL (second row signal lines: GL5 to GL8, GL13 to GL16, . . . , GLn−3 to GLn), which are arranged in the vertical direction, the plurality of image elements 110 (first image elements), which are arranged at the intersections between the first row signal lines and the column signal lines SL1 to SLm, and the plurality of image elements 110 (second image elements), which are arranged at the intersections between the second row signal lines and the column signal lines SL1 to SLm. The display system 1A further includes the gate driver circuit 20 (driver circuit) including the plurality of drive circuits DRV (first drive circuits), each of which is disposed for a corresponding one of the first row signal lines and drives corresponding two or more of the first image elements via the corresponding one of the first row signal lines, and the plurality of drive circuits DRV (second drive circuits), each of which is disposed for a corresponding one of the second row signal lines and drives corresponding two or more of the second image elements via the corresponding one of the second row signal lines. In the display system 1A, moreover, each of the first drive circuits supplies electric charge to the corresponding two or more of the first image elements during the first period (time t75 to t76 in FIG. 7) but extracts the electric charge from the corresponding two or more of the first image elements during the second period (time t73 to t74 in FIG. 7) different from the first period. Further, in the display system 1A, each of the second drive circuits supplies electric charge to the corresponding two or more of the second image elements during the third period (time t73 to t74 in FIG. 7), at least part of which overlaps with the second period, but extracts the electric charge from the corresponding two or more of the second image elements during the fourth period (time t75 to t76 in FIG. 7), at least part of which overlaps with the first period.

In the display system 1A configured as described above, in some cases, at least part of the magnetic field noise and electric field noise emitted from the display system 1A during the first period in which electric charge is supplied to the first image elements is offset by the magnetic field noise and electric field noise emitted from the display system 1A during the fourth period in which electric charge is extracted from the second image elements. Moreover, in some cases, at least part of the magnetic field noise and electric field noise emitted from the display system 1A during the second period in which electric charge is extracted from the first image elements is offset by the magnetic field noise and electric field noise emitted from the display system 1A during the third period in which electric charge is supplied to the second image elements. Thus, the display system 1A can reduce the noise emitted from the display system 1A.

Further, in the present embodiment, the display system 1A further includes the first clock lines WCL1 to WCL4, which respectively supply the first clocks CLK1 to CLK4 to the first drive circuits, and the second clock lines WCL5 to WCL8, which respectively supply the second clocks CLK5 to CLK8 to the second drive circuits. Further, in the display system 1A, each of the first drive circuits performs one of supply and extraction of the electric charge to and from the corresponding two or more of the first image elements according to the alternation of the first clocks CLK1 to CLK4. Further, in the display system 1A, each of the second drive circuits performs one of supply and extraction of the electric charge to and from the corresponding two or more of the second image elements according to the alternation of the second clocks CLK5 to CLK8. Further, in the display system 1A, the first clock lines WCL1 to WCL4 and the second clock lines WCL5 to WCL8 are arranged parallel and adjacent to each other.

In the display system 1A configured as described above, at least part of the magnetic field noise and electric field noise emitted from the first clock lines WCL1 to WCL4 is offset by the magnetic field noise and electric field noise emitted from the second clock lines WCL5 to WCL8, which are arranged parallel and adjacent to the first clock lines WCL1 to WCL4. Further, at least part of the magnetic field noise and electric field noise emitted from the second clock lines WCL5 to WCL8 is also offset by the magnetic field noise and electric field noise emitted from the first clock lines WCL1 to WCL4. Thus, the display system 1A can reduce the noise emitted from the display system 1A.

In the present embodiment, the first drive circuits and the second drive circuits are alternately connected in series. Each of the first drive circuits retains information indicated by a gate signal (VG5 to VG8, VG13 to VG16, . . . , VGn−11 to VGn−8) output from a corresponding one of the second drive circuits that is connected to the preceding stage and outputs a gate signal (VG9 to VG12, VG17 to VG20, . . . , VGn−7 to VGn−4) including the information retained during the first period to a corresponding one of the second drive circuits that is connected to the subsequent stage. Further, each of the second drive circuits retains information indicated by a gate signal (VG1 to VG4, VG9 to VG12, . . . , VGn−15 to VGn−12) output from a corresponding one of the first drive circuits that is connected to the preceding stage and outputs a gate signal (VG5 to VG8, VG13 to VG16, . . . , VGn−11 to VGn−8) including the information retained during the third period to a corresponding one of the first drive circuits that is connected to the subsequent stage. Further, each of the first drive circuits initializes the retained information according to a gate signal (VG9 to VG12, . . . , VGn−7 to VGn−4) output from a corresponding one of the first drive circuits that is connected to a stage immediately following or following the subsequent stage or according to a gate signal (VG13 to VG16, . . . , VGn−3 to VGn) output from a corresponding one of the second drive circuits that is connected to a stage immediately following or following the subsequent stage. Further, each of the second drive circuits initializes the retained information according to a gate signal (VG13 to VG16, . . . , VGn−3 to VGn) output from a corresponding one of the second drive circuits that is connected to a stage immediately following or following the subsequent stage or according to a gate signal (VG17 to VG20, . . . , VGn−7 to VGn−4) output from a corresponding one of the first drive circuits that is connected to a stage immediately following or following the subsequent stage.

In the display system 1A configured as described above, each of the first drive circuits and the second drive circuits performs initialization according to a gate signal VG output from the first drive circuit or the second drive circuit connected to a stage immediately following or following the subsequent stage. Accordingly, the display system 1A can reserve a sufficient margin period from the time when the first drive circuit and the second drive circuit respectively drive the first row signal line and the second row signal line to the time when the first drive circuit and the second drive circuit perform initialization.

### Second Embodiment

Next, a second embodiment is described.

Configurations

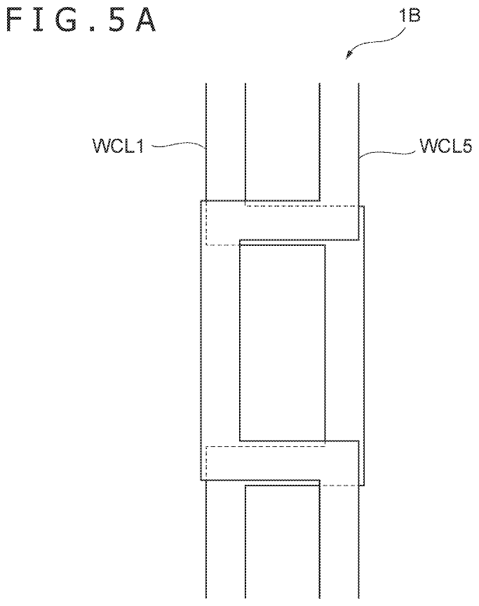

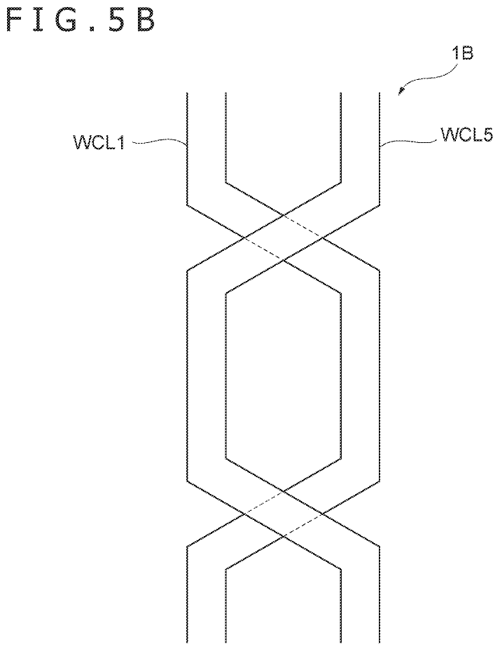

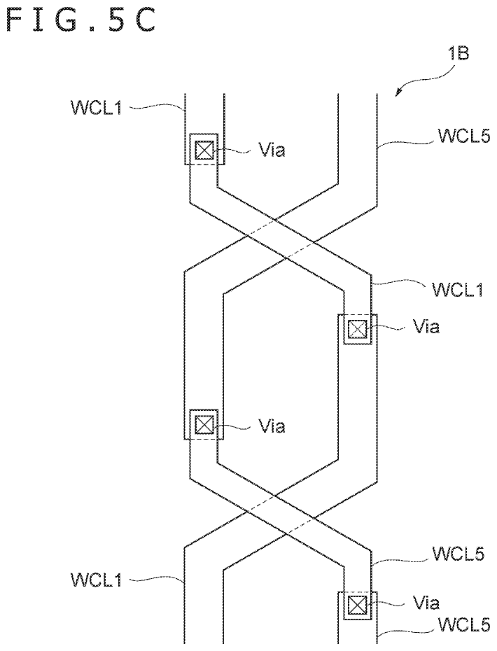

FIG. 5A is a diagram illustrating a second example of the arrangement of the clock lines WCL1 and WCL5. FIG. 5B is a diagram illustrating a third example of the arrangement of the clock lines WCL1 and WCL5. FIG. 5C is a diagram illustrating a fourth example of the arrangement of the clock lines WCL1 and WCL5. Although not illustrated, in FIGS. 5A, 5B, and 5C, the clock lines WCL2 to WCL8 are assumed to be arranged in the same way as the clock lines WCL1 and WCL5. Since a display system 1B is the same as the display system 1A according to the first embodiment except that they differ in the arrangement of the clock lines WCL1 to WCL8, description of parts that are the same as those of the display system 1A is omitted.

As illustrated in FIGS. 5A, 5B, and 5C, in the display system 1B, the clock lines WCL1 and WCL5 are arranged in such a manner as to be adjacent and parallel to each other and cross each other at regular distances.

In FIG. 5A, in the display system 1B, the clock line WCL5 is arranged on an upper layer of the layer in which the clock line WCL1 is arranged. Further, the clock lines WCL1 and WCL5 are arranged in the display system 1B in the form of a rectangular wave that travels between the right lane and the left lane at regular distances. Further, the clock lines WCL1 and WCL5 are arranged in such a manner that their vertical positions of the horizontal lines when traveling to the opposite lane overlap with each other. In this example, as described above, the clock line WCL5 is arranged on the upper layer of the layer in which the clock line WCL1 is arranged. However, the present example is not limited thereto. The clock line WCL1 may be arranged on an upper layer of the layer in which the clock line WCL5 is arranged.

In FIG. 5B, in the display system 1B, the clock line WCL5 is arranged on an upper layer of the layer in which the clock line WCL1 is arranged. Further, the clock lines WCL1 and WCL5 are arranged in the display system 1B in the form of a trapezoidal wave that travels between the right lane and the left lane at regular distances. Further, the clock lines WCL1 and WCL5 are arranged in such a manner that their vertical positions when traveling to the opposite lane overlap with each other. In this example, as described above, the clock line WCL5 is arranged on the upper layer of the layer in which the clock line WCL1 is arranged. However, the present example is not limited thereto. The clock line WCL1 may be arranged on an upper layer of the layer in which the clock line WCL5 is arranged.

In FIG. 5C, in the display system 1B, each of the clock lines WCL1 and WCL5 includes a lower layer line arranged on the lower layer, an upper layer line arranged on the upper layer, and vias Via that electrically connect the lower and upper layer lines.

The lower layer line has a shape that extends from an upper end toward a lower direction on the right lane, then extends further to the left lane in a lower left direction, and extends further in the lower direction on the left lane, reaching a lower end. The lower end and the upper end of the lower layer line are connected to an upper end and a lower end of the upper layer line via the vias Via, respectively.

The upper layer line has a shape that extends from the upper end toward the lower direction on the left lane, then extends further to the right lane in a lower right direction, and extends further in the lower direction on the right lane, reaching the lower end. The lower end and the upper end of the upper layer line are connected to the upper end and the lower end of the lower layer line via the vias Via, respectively.

Moreover, in the display system 1B, the clock lines WCL1 and WCL5 are arranged in such a manner that the lower layer line of the clock line WCL1 and the upper layer line of the clock line WCL5 cross each other and the upper layer line of the clock line WCL1 and the lower layer line of the clock line WCL5 cross each other.

Advantageous Effects

In the second embodiment described above, the display system 1B further includes the first clock lines WCL1 to WCL4, which respectively supply the first clocks CLK1 to CLK4 to the respective first drive circuits, and the second clock lines WCL5 to WCL8, which respectively supply the second clocks CLK5 to CLK8 to the respective second drive circuits. In the display system 1B, each of the first drive circuits performs one of supply and extraction of the electric charge to and from the corresponding two or more of the first image elements according to the alternation of the respective first clocks CLK1 to CLK4. In the display system 1B, each of the second drive circuits performs one of supply and extraction of the electric charge to and from the corresponding two or more of the second image elements according to the alternation of the respective second clocks CLK5 to CLK8. Further, in the display system 1B, the first clock lines WCL1 to WCL4 and the second clock lines WCL5 to WCL8 are arranged in such a manner that the first clock lines WCL1 to WCL4 respectively cross the second clock lines WCL5 to WCL8 at regular distances.

In the display system 1B configured as illustrated in FIG. 5A, the first clock lines WCL1 to WCL4 respectively cross the second clock lines WCL5 to WCL8 at regular distances. Compared to the case where the first clock lines WCL1 to WCL4 and the second clock lines WCL5 to WCL8 do not cross each other, the display system 1B can thus further reduce noise emitted from the display system 1B.

In the display system 1B configured as illustrated in FIG. 5B, the area of the regions in which the upper layers and the lower layers of the first clock lines WCL1 to WCL4 and the second clock lines WCL5 to WCL8 overlap with each other is reduced. Compared to the configuration illustrated in FIG. 5A, the display system 1B can thus further reduce noise emitted from the display system 1B.

In the display system 1B configured as illustrated in FIG. 5C, the first clock lines WCL1 to WCL4 and the second clock lines WCL5 to WCL8 use the upper layer only for the portions where the first clock lines WCL1 to WCL4 respectively cross the second clock lines WCL5 to WCL8. Compared to the configurations illustrated in FIGS. 5A and 5B, the display system 1B can thus reduce variations of the electric characteristics (wiring resistance) caused by the difference between the upper layer and the lower layer.

### Third Embodiment

Next, a third embodiment is described.

Flow of Series of Operations of Display System 1C

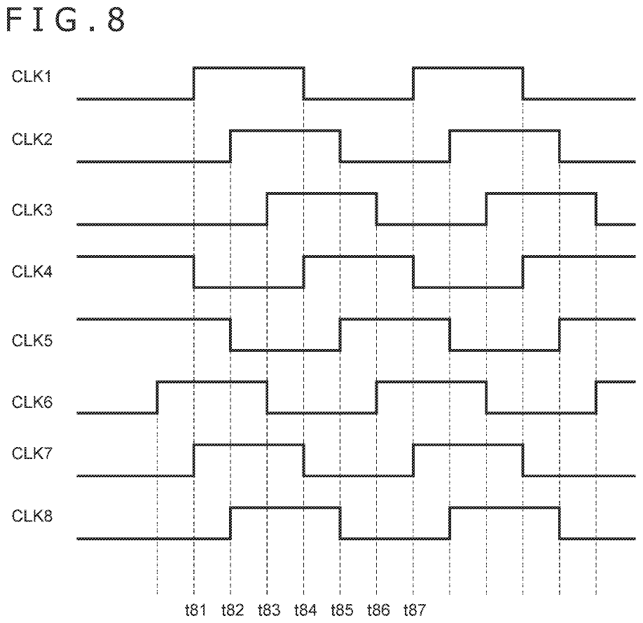

FIG. 8 is a timing chart illustrating an example of the transition of the potentials of the clocks CLK1 to CLK8 in a display system 1C according to the third embodiment. In the display system 1C, the reset terminal R of each drive circuit DRV in the gate driver circuit 20 receives a gate signal VG (not illustrated) output from the drive circuit DRV connected to the stage immediately following or following the subsequent stage in the corresponding shift register 201. Since the display system 1C is the same as the display system 1A according to the first embodiment except that they differ in the phase differences between the clocks CLK1 to CLK8 and the drive circuits DRV that output the gate signals VG to be input into the reset terminals R of the drive circuits DRV, description of parts that are the same as those of the display system 1A according to the first embodiment is omitted.

At time t81, the control circuit 40 causes the potential of the clock CLK1 to transition from the low level to the high level, also causes the potential of the clock CLK4 to transition from the high level to the low level, and further causes the potential of the clock CLK7 to transition from the low level to the high level.

At time t82, the control circuit 40 causes the potential of the clock CLK2 to transition from the low level to the high level, also causes the potential of the clock CLK5 to transition from the high level to the low level, and further causes the potential of the clock CLK8 to transition from the low level to the high level.

At time t83, the control circuit 40 causes the potential of the clock CLK3 to transition from the low level to the high level and also causes the potential of the clock CLK6 to transition from the high level to the low level.

At time t84, the control circuit 40 causes the potential of the clock CLK1 to transition from the high level to the low level, also causes the potential of the clock CLK4 to transition from the low level to the high level, and further causes the potential of the clock CLK7 to transition from the high level to the low level.

At time t85, the control circuit 40 causes the potential of the clock CLK2 to transition from the high level to the low level, also causes the potential of the clock CLK5 to transition from the low level to the high level, and further causes the potential of the clock CLK8 to transition from the high level to the low level.

At time t86, the control circuit 40 causes the potential of the clock CLK3 to transition from the high level to the low level and also causes the potential of the clock CLK6 to transition from the low level to the high level.

At and after time t87, the control circuit 40 causes the potentials of the clocks CLK1 to CLK8 to transition in the same manner as that in time t81 to t86.

### Advantageous Effects

In the third embodiment, in the display system 1C, the plurality of drive circuits DRV (first drive circuits) are alternately connected in series. Each of the first drive circuits retains information indicated by a gate signal (VG1, VG5, VGn−7) output from a corresponding one of the first drive circuits that is connected to the preceding stage and outputs a gate signal (VG5, VG9, VGn−3) including the information retained during the first period to a corresponding one of the first drive circuits that is connected to the subsequent stage. In the display system 1C, moreover, the plurality of drive circuits DRV (second drive circuits) are alternately connected in series. Each of the second drive circuits retains information indicated by a gate signal (VG4, VG8, VGn−4) output from a corresponding one of the second drive circuits that is connected to the preceding stage and outputs a gate signal (VG8, VG12, VGn) including the information retained during the third period to a corresponding one of the second drive circuits that is connected to the subsequent stage.

In the display system 1C configured as described above, the first drive circuits are connected to each other in series, and the second drive circuits are connected to each other in series. Further, the periods in which the first drive circuits perform supply and extraction of the electric charge to and from the first image elements overlap with the periods in which the second drive circuits perform extraction and supply of the electric charge to and from the second image elements. In the display system 1C, the connection system used by the first drive circuits is different from the connection system used by the second drive circuits. Hence, the display system 1C has more time margin at the timings of initialization of the information retained by the first drive circuits and the information retained by the second drive circuits.

### Fourth Embodiment

Next, a fourth embodiment is described.

Configurations

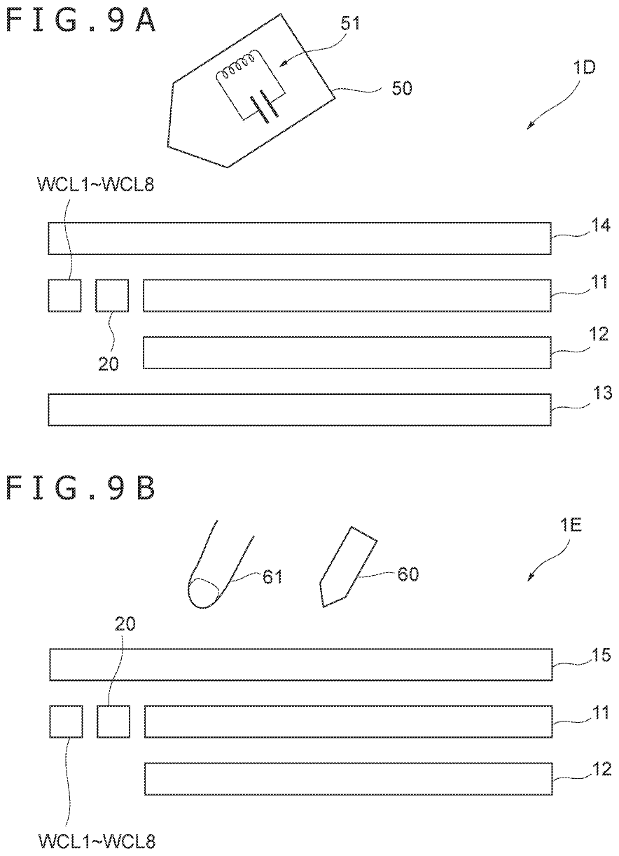

FIG. 9A is a cross-sectional view of a display system 1D according to the fourth embodiment. As illustrated in FIG. 9A, the display system 1D further includes a drive coil 13, a position detector 14, and a position indicator 50.

The drive coil 13 transmits, to the position indicator 50, a signal having a predetermined frequency for detecting the position of the position indicator 50. The drive coil 13 is disposed in a planar form on the side of a back surface of the display device 10 in such a manner to include at least the range of a display surface of the display module 11 when the display system 1D is viewed from the display surface.

The position indicator 50 is a pointing device that indicates a predetermined position on the display module 11. The position indicator 50 includes a resonance circuit 51, which includes an inductive element such as a coil and a capacitive element such as a capacitor. The position indicator 50 resonates the resonance circuit 51 by a signal transmitted from the drive coil 13 and transmits a resonance signal generated by this resonance to the position detector 14, thereby communicating the predetermined position on the display module 11 it has indicated, to the position detector 14.

The position detector 14 is, for example, an electro-magnetic resonance (EMR) sensor and detects a predetermined position on the display module 11 indicated by the position indicator 50 by receiving the resonance signal transmitted from the position indicator 50. The position detector 14 includes a plurality of electro-magnetic resonance detection coils, which are disposed in a planar form on the side of the display surface of the display device 10 in such a manner as to include at least the range of the display surface of the display module 11 when the display system 1D is viewed from the display surface. The position detector 14 detects the position of a detection coil that has the highest received signal level as the predetermined position on the display module 11 indicated by the position indicator 50.

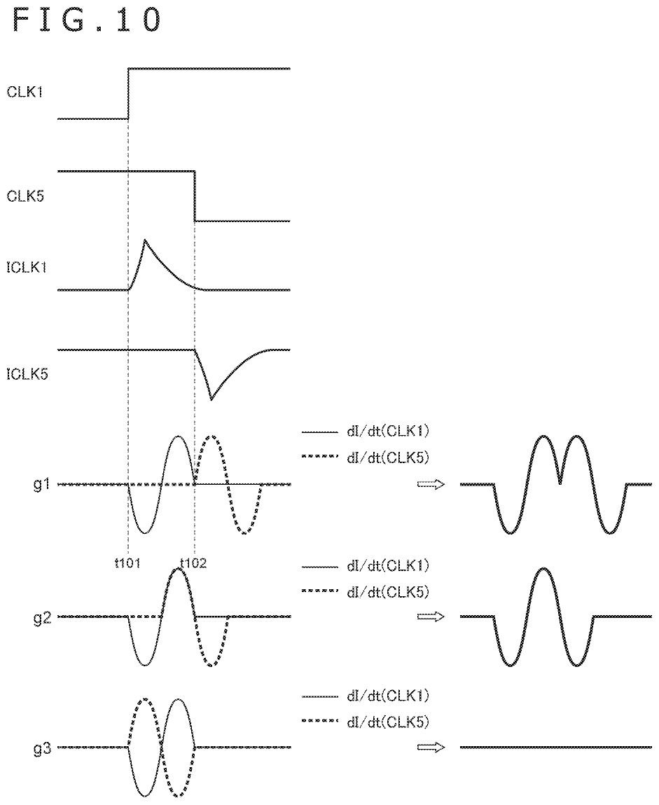

FIG. 10 is a set of graphs illustrating a relation between the alternation of the clocks CLK1 and CLK5 and an electromotive force generated in the position detector 14 in the display system 1D.

At time t101, the control circuit 40 causes the potential of the clock CLK1 to transition from the low level to the high level. Accordingly, a current ICLK1 flowing in the clock line WCL1 rises sharply and then falls slowly back to 0. Further, along with the change in the value of the current flowing in the clock line WCL1, an electromotive force dI/dt (CLK1) generated in the detection coils of the position detector 14 changes in the order of descending, ascending, and descending, and then returns to 0.

At time t102, the control circuit 40 causes the potential of the clock CLK5 to transition from the high level to the low level. Accordingly, a current ICLK5 flowing in the clock line WCL5 falls sharply and then rises slowly back to 0. Further, as illustrated in the graph g1, along with the change in the value of the current flowing in the clock line WCL5, an electromotive force dI/dt (CLK5) generated in the detection coils of the position detector 14 changes in the order of ascending, descending, and ascending, and then returns to 0.

A graph g2 illustrates the electromotive force generated in the detection coils of the position detector 14 in the case where the rising timing (time t101) of the clock CLK1 and the falling timing (time t102) of the clock CLK5 are closer to each other than in the case of the graph g1. A graph g3 illustrates the electromotive force generated in the detection coils of the position detector 14 in the case where the rising timing (time t101) of the clock CLK1 and the falling timing (time t102) of the clock CLK5 are closer to each other than in the case of the graph g2.

The right side of FIG. 10 illustrates the electromotive force that is the sum of the electromotive force generated in the detection coils by the rising edge of the clock CLK1 and the electromotive force generated in the detection coils by the falling edge of the clock CLK1.

As illustrated in FIG. 10, it can be understood that as the rising timing (time t101) of the clock CLK1 and the falling timing (time t102) of the clock CLK5 are closer to each other, the electromotive force generated in the detection coils decreases by the alternation of the clocks CLK1 and CLK5.

Advantageous Effects

In the fourth embodiment, the display system 1D further includes the position indicator 50, which includes the resonance circuit 51, the drive coil 13, which supplies power to the position indicator 50, and the position detector 14, which includes the electro-magnetic resonance detection coils that detect the position indicated by the position indicator 50.

In the display system 1D configured as described above, at least part of the magnetic field noise emitted from the display system 1D during the first period in which electric charge is supplied to the first image elements is offset by the magnetic field noise emitted from the display system 1D during the fourth period in which electric charge is extracted from the second image elements. Moreover, at least part of the magnetic field noise emitted from the display system 1D during the second period in which electric charge is extracted from the first image elements is offset by the magnetic field noise emitted from the display system 1D during the third period in which electric charge is supplied to the second image elements. By reducing the magnetic field noise, the display system 1D can increase the accuracy of the detection of the position of the position indicator 50 by the position detector 14.

In the fourth embodiment, the gate driver circuit 20 is disposed between the position detector 14 and the drive coil 13 and on a side of a side surface of the display device 10. Further, in the display system 1D, the first clock lines WCL1 to WCL4 and the second clock lines WCL5 to WCL8 are arranged between the position detector 14 and the drive coil 13 and on a side of a side surface of the gate driver circuit 20 opposite to the display device 10. Further, in the display system 1D, the position detector 14 is disposed on a side of the display surface of the display device 10 with respect to the display device 10, the gate driver circuit 20, the first clock lines WCL1 to WCL4, and the second clock lines WCL5 to WCL8. In the display system 1D, further, the drive coil 13 is disposed on a side of the back surface of the display device 10 with respect to the display device 10, the gate driver circuit 20, the first clock lines WCL1 to WCL4, and the second clock lines WCL5 to WCL8.

In the display system 1D configured as described above, the magnetic field noise of the first clock lines WCL1 to WCL4 and the second clock lines WCL5 to WCL8 that is generated near the side of the side surface of the gate driver circuit 20 is reduced. Accordingly, the position detector 14 can detect the position of the position indicator 50 with increased accuracy near the side of the side surface of the gate driver circuit 20.

### Fifth Embodiment

Next, a fifth embodiment is described.

Configurations

FIG. 9B is a cross-sectional view illustrating an arrangement relation of a display system 1E that includes a touch sensor 15. As illustrated in FIG. 9B, the display system 1E further includes the touch sensor 15 and a stylus 60.

The touch sensor 15 detects the position of the stylus 60 or a finger 61 when the stylus 60 or the finger 61 touches or approaches the touch sensor 15. The touch sensor 15 includes a plurality of detection electrodes, which are arranged in a planar form on the side of the display surface of the display device 10 in such a manner as to include at least the range of the display surface of the display module 11 when the display system 1E is viewed from the display surface. The touch sensor 15 detects the position of a detection electrode that has the highest received signal level as a predetermined position on the display module 11 indicated by the stylus 60 or the finger 61.

The stylus 60 is a pointing device for indicating a predetermined position on the touch sensor 15. The stylus 60 operates in response to the reception of signals transmitted from the detection electrodes of the touch sensor 15. The stylus 60 transmits a signal for indicating the position from the tip of the stylus 60 to the detection electrodes, thereby communicating position information to the touch sensor 15.

### Advantageous Effects

In the fifth embodiment described above, the display device 10 includes the touch sensor 15, which includes the plurality of detection electrodes arranged in a planar form. In the display system 1E, moreover, the gate driver circuit 20 is disposed on the side of the side surface of the display device 10 and on a side of a back surface of the touch sensor 15. Further, in the display system 1E, the first clock lines WCL1 to WCL4 and the second clock lines WCL5 to WCL8 are arranged on the side of the back surface of the touch sensor 15 and on the side of the side surface of the gate driver circuit 20 opposite to the display device 10. In the display system 1E, further, the touch sensor 15 is disposed on the side of the display surface of the display device 10 with respect to the display device 10, the gate driver circuit 20, the first clock lines WCL1 to WCL4, and the second clock lines WCL5 to WCL8.

In the display system 1E configured as described above, at least part of the electric field noise emitted from the display system 1E during the first period in which electric charge is supplied to the first image elements is offset by the electric field noise emitted from the display system 1E during the fourth period in which electric charge is extracted from the second image elements. Moreover, at least part of the electric field noise emitted from the display system 1E during the second period in which electric charge is extracted from the first image elements is offset by the electric field noise emitted from the display system 1E during the third period in which electric charge is supplied to the second image elements. By reducing the electric field noise, the display system 1E can thus increase the accuracy of the detection of the position of the stylus 60 or the finger 61 by the touch sensor 15.

### Modifications

The present disclosure is not limited to the embodiments described above. That is, design modifications made to the above-described embodiments by those skilled in the art as appropriate also fall within the scope of the present disclosure as long as the modifications have the features of the present disclosure. In addition, the elements included in the embodiments described above and modifications to be described below can be combined as long as such combinations are technically possible, and such combinations also fall within the scope of the present disclosure as long as the combinations have the features of the present disclosure.

For example, although the gate driver circuit 20 is disposed on the side of one side surface of the display device 10 in the embodiments described above, the present disclosure is not limited thereto. For example, the gate driver circuit 20 may be disposed on both sides of opposing side surfaces of the display device 10.

With this configuration in which the gate driver circuit 20 is disposed on both sides of the opposing side surfaces of the display device 10, a display system 1 can reduce noise.

Further, although the number of clock lines WCL is eight in the embodiments described above, the number of clock lines WCL is not limited to eight, and any number of clock lines WCL may be disposed.

With this configuration, the display system 1 can reduce noise regardless of the number of clock lines WCL.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display system comprising:
a display device including:
a plurality of column signal lines arranged in a horizontal direction,
a plurality of first row signal lines arranged in a vertical direction,
a plurality of second row signal lines arranged in the vertical direction,
a plurality of first image elements arranged at intersections between the first row signal lines and the column signal lines, and
a plurality of second image elements arranged at intersections between the second row signal lines and the column signal lines; and
a driver circuit including:
a plurality of first drive circuits, each disposed for a corresponding one of the first row signal lines and, in operation, drives two or more corresponding ones of the first image elements via the corresponding one of the first row signal lines, and
a plurality of second drive circuits, each disposed for a corresponding one of the second row signal lines and, in operation, drives two or more corresponding ones of the second image elements via the corresponding one of the second row signal lines,
wherein each of the first drive circuits, in operation, supplies first electric charge to the two or more corresponding ones of the first image elements during a first period and extracts the first electric charge from the two or more corresponding ones of the first image elements during a second period different from the first period, and
wherein each of the second drive circuits, in operation, supplies second electric charge to the two or more corresponding ones of the second image elements during a third period, at least part of which overlaps with the second period, or extracts the second electric charge from the two or more corresponding ones of the second image elements during a fourth period, at least part of which overlaps with the first period.

2. The display system according to claim 1, further comprising:
a first clock line that couples a first clock to the first drive circuits; and
a second clock line that couples a second clock to the second drive circuits,
wherein each of the first drive circuits, in operation, supplies the first electric charge to or extracts the first electric charge from the two or more corresponding ones of the first image elements according to alternation of the first clock,
wherein each of the second drive circuits, in operation, supplies the second electric charge to or extracts the second electric charge from the two or more corresponding ones of the second image elements according to alternation of the second clock, and
wherein the first clock line and the second clock line are arranged parallel and adjacent to each other.

3. The display system according to claim 1, further comprising:
a first clock line that couples a first clock to the first drive circuits; and
a second clock line that couples a second clock to the second drive circuits,
wherein each of the first drive circuits, in operation, supplies the first electric charge to or extracts the first electric charge from the two or more corresponding ones of the first image elements according to alternation of the first clock,
wherein each of the second drive circuits, in operation, supplies the second electric charge to or extracts the second electric charge from the two or more corresponding ones of the second image elements according to alternation of the second clock, and
wherein the first clock line and the second clock line cross each other at regular distances.

4. The display system according to claim 1, wherein:
the first drive circuits and the second drive circuits are alternately connected in series,
each of the first drive circuits, in operation, retains information indicated by a signal output from a corresponding one of the second drive circuits that is connected to a preceding stage and outputs a signal including the information retained during the first period to a corresponding one of the second drive circuits that is connected to a subsequent stage,
each of the second drive circuits, in operation, retains information indicated by a signal output from a corresponding one of the first drive circuits that is connected to a preceding stage and outputs a signal including the information retained during the third period to a corresponding one of the first drive circuits that is connected to a subsequent stage,
each of the first drive circuits, in operation, initializes the information retained therein according to a signal output from a corresponding one of the first drive circuits that is connected to a stage immediately following or following the subsequent stage or according to a signal output from a corresponding one of the second drive circuits that is connected to a stage immediately following or following the subsequent stage, and
each of the second drive circuits, in operation, initializes the information retained therein according to a signal output from a corresponding one of the first drive circuits that is connected to a stage immediately following or following the subsequent stage or according to a signal output from a corresponding one of the second drive circuits that is connected to a stage immediately following or following the subsequent stage.

5. The display system according to claim 1, wherein:
the plurality of first drive circuits are alternately connected in series,
each of the first drive circuits, in operation, retains information indicated by a signal output from a corresponding one of the first drive circuits that is connected to a preceding stage and outputs a signal including the information retained during the first period to a corresponding one of the first drive circuits that is connected to a subsequent stage,
the plurality of second drive circuits are alternately connected in series, and
each of the second drive circuits, in operation, retains information indicated by a signal output from a corresponding one of the second drive circuits that is connected to a preceding stage and outputs a signal including the information retained during the third period to a corresponding one of the second drive circuits that is connected to a subsequent stage.

6. The display system according to claim 2, further comprising:
a position indicator including a resonance circuit;
a drive coil that, in operation, supplies power to the position indicator; and
a position detector including an electro-magnetic resonance detection coil that, in operation, detects a position indicated by the position indicator.

7. The display system according to claim 6, wherein:
the driver circuit is disposed between the position detector and the drive coil and on a side of a side surface of the display device,
the first clock line and the second clock line are arranged between the position detector and the drive coil and on a side of a side surface of the driver circuit opposite to the display device,
the position detector is disposed on a side of a display surface of the display device with respect to the display device, the driver circuit, the first clock line, and the second clock line, and
the drive coil is disposed on a side of a back surface of the display device with respect to the display device, the driver circuit, the first clock line, and the second clock line.

8. The display system according to claim 2, wherein the display device further includes a touch sensor including a plurality of detection electrodes arranged in a planar form.

9. The display system according to claim 8, wherein:
the driver circuit is disposed on a side of a side surface of the display device and on a side of a back surface of the touch sensor,
the first clock line and the second clock line are arranged on the side of the back surface of the touch sensor and on a side of a side surface of the driver circuit opposite to the display device, and
the touch sensor is disposed on a side of a display surface of the display device with respect to the display device, the driver circuit, the first clock line, and the second clock line.

10. A driver circuit for driving a plurality of first image elements and a plurality of second image elements in a display device, the display device including: a plurality of column signal lines arranged in a horizontal direction, a plurality of first row signal lines arranged in a vertical direction, a plurality of second row signal lines arranged in the vertical direction, the plurality of first image elements arranged at intersections between the first row signal lines and the column signal lines, and the plurality of second image elements arranged at intersections between the second row signal lines and the column signal lines, the driver circuit comprising:
a plurality of first drive circuits, each disposed for a corresponding one of the first row signal lines and, in operation, drives two or more corresponding ones of the first image elements via the corresponding one of the first row signal lines; and
a plurality of second drive circuits, each disposed for a corresponding one of the second row signal lines and, in operation, drives two or more corresponding ones of the second image elements via the corresponding one of the second row signal lines,
wherein each of the first drive circuits, in operation, supplies first electric charge to the two or more corresponding ones of the first image elements during a first period and extracts the first electric charge from the two or more corresponding ones of the first image elements during a second period different from the first period, and
each of the second drive circuits, in operation, supplies second electric charge to the two or more corresponding ones of the second image elements during a third period, at least part of which overlaps with the second period, or extracts the second electric charge from the two or more corresponding ones of the second image elements during a fourth period, at least part of which overlaps with the first period.

11. A method for controlling a display system, the display system including: a plurality of column signal lines arranged in a horizontal direction, a plurality of first row signal lines arranged in a vertical direction, a plurality of second row signal lines arranged in the vertical direction, a plurality of first image elements arranged at intersections between the first row signal lines and the column signal lines, and a plurality of second image elements arranged at intersections between the second row signal lines and the column signal lines, the method comprising:
supplying first electric charge to the first image elements via the first row signal lines during a first period;
extracting the first electric charge from the first image elements via the first row signal lines during a second period different from the first period;
supplying second electric charge to the second image elements via the second row signal lines during a third period, at least part of which overlaps with the second period; and
extracting the second electric charge from the second image elements via the second row signal lines during a fourth period, at least part of which overlaps with the first period.
